(19) United States
(12) Patent Application Publication
(10) Pub. No.: US 2022/0043517 A1
(43) Pub. Date: Feb. 10, 2022

(54) MULTI-MODAL TOUCHPAD

(71) Applicant: INTERLINK ELECTRONICS, INC., Irvine, CA (US)

(72) Inventors: Chee Wai LU, Singapore (SG); Wai Jye CHAN, Singapore (SG); Cheng Seong LEE, Singapore (SG); Yen Ching LIM, Singapore (SG)

(73) Assignee: INTERLINK ELECTRONICS, INC., Irvine, CA (US)

(21) Appl. No.: 17/279,020

(22) PCT Filed: Sep. 24, 2019
(86) PCT No.: PCT/US2019/052794

§ 371 Date: Mar. 23, 2021

Related U.S. Application Data
(60) Provisional application No. 62/735,545, filed on Sep. 24, 2018.

(51) Int. Cl. G06F 3/01; G06F 3/041; G06F 3/0488

(52) U.S. Cl. CPC G06F 3/016; G06F 3/0414; G06F 3/0418; G06F 2203/04106; G06F 2203/014; G06F 2203/04101; G06F 2203/04105; G06F 3/0488

(57) ABSTRACT

A multi-modal touchpad can include: a touchscreen; at least one type of input sensor; a motion sensor; a haptic feedback device; and a multi-modal controller operably coupled with: the at least one type of input sensor so as to receive sensor data therefrom; the motion sensor so as to receive motion sensor data therefrom; the haptic feedback device so as to provide instructional haptic data to the haptic feedback device; a data interface that operably couples the multi-modal controller with an operating system of a device having the multi-modal touchpad; and a graphics user interface provided from the multi-modal controller to the display so as to display data from the multi-modal controller to the display. The at least one type of sensor can include a force sensor or a proximity sensor operably coupled with the physical sensing surface.

### BACKGROUND

A common computer user interface system includes the use of a touchpad, such as a dedicated touchpad or a touchscreen. The touchpad provides key functions including cursor pointing/movement control and display scrolling/viewing control. The touchpad can be in various configurations ranging from separate touchpads (e.g., dedicated touchpad) common on laptop computers to display screen touchscreens on common smart phones, tables, handhelds, and like computers. While the touchpad is a useful tool for enabling human interaction with a computer, there remains room for improving touchpads to improve how humans interact with the touchpad to communicate with the computer and also receive communications from the touchpad.

Therefore, there remains a need to provide improved touchpads to further develop the way humans interact with all types of computing devices.

### SUMMARY

In one embodiment, a multi-modal touchpad can include: a display having a physical sensing surface and configured as a touchscreen; at least one type of sensor operably coupled with the physical sensing surface; a motion sensor; a haptic feedback device operably coupled with the physical sensing surface; and a multi-modal controller operably coupled with: the at least one type of sensor so as to receive sensor data therefrom; the motion sensor so as to receive motion sensor data therefrom; the haptic feedback device so as to provide instructional haptic data to the haptic feedback device; a data interface that operably couples the multi-modal controller with an operating system of a device having the multi-modal touchpad; and a graphics user interface provided from the multi-modal controller to the display so as to display data from the multi-modal controller to the display. In some aspects, the at least one type of sensor can include: a force sensor operably coupled with the physical sensing surface, wherein the multi-modal controller is operably coupled with the force sensor so as to receive force sensor data from the force sensor. In some aspects, the at least one type of sensor can include: a proximity sensor operably coupled with the physical sensing surface, wherein the multi-modal controller is operably coupled with the proximity sensor so as to receive proximity sensor data from the proximity sensor. In some aspects, the display is operable coupled with the multi-modal controller so as to receive display data from the multi-modal controller, wherein the display is a touch screen display, and the physical sensing surface is a surface of the display.

In some embodiments, the multi-modal controller receives data from the data interface such that the multi-modal controller receives data to display on the display. In some aspects, the multi-modal controller is configured to provide a virtual sensor region on the display with respect to the data from the data interface. In some aspects, the multi-modal controller is configured to define at least one of a force sensing region or proximity sensing zone on the display. In some aspects, the multi-modal controller receives sensor data from the at least one type of sensor and provides haptic feedback data to the haptic feedback device.

In some embodiments, the force sensor is at least one force sensor configured as: a discrete contact sensor; and/or a variable force sensor. In some aspects, the multi-modal controller is configured to: generate and display a force sensing virtual button; receive an input to the force sensing virtual button; and implement an operation based on the input to the force sensing virtual button. In some aspects, the multi-modal controller is configured to: generate and display a proximity sensing zone; receive an input above the proximity sensing zone; and implement an operation based on the input to the proximity sensing zone.

In some embodiments, the multi-modal controller is configured to determine whether or not the multi-modal touchpad is in motion or stationary. In some aspects, the multi-modal controller is configured to: determine whether an input into the physical sensing surface is a true input, and if so, then implement an operation consistent with the true input; and/or determine whether an input into the physical sensing surface is a false input, and if so, then omitting an operation of the false input. This determination of a true or false input can be performed while the motion sensor is sensing that the device is in motion, or it can be performed even when stationary.

In some embodiments, a device can include: the multi-modal touchpad of one of the embodiments; and a housing having the multi-modal touchpad.

In some embodiments, a kit can include: the device of one of the embodiments; and a stylus configured for use with the device.

In some embodiments, a method of operating a device with a multi-modal touchpad can include: providing the device of one of the embodiments having the multi-modal touchpad; and inputting data by interacting with the multi-modal touchpad by proximity actions and/or touch actions such that the multi-modal controller receives input data from the proximity sensor and/or the force sensor and provides output data to the display and the haptic feedback device. In some aspects, the multi-model controller determines whether the device is in motion or stationary.

In some embodiments, the method can include: receiving data from the data interface such that the multi-modal controller receives data to display on the display; and providing a virtual sensor region on the display with respect to the data from the data interface by the multi-modal controller. In some aspects, the method can include defining at least one of a force sensing region or proximity sensing zone on the display by the multi-modal controller. In some aspects, the haptic feedback device provides a haptic feedback, wherein the multi-modal controller receives an input and generates haptic feedback data in response to the input.

In some embodiments, the method can include interacting with the multi-modal touchpad by performing touch actions that are discrete contact touches and/or variable force contact touches. In some aspects, the method can include implementing an activation and force sensing gesture with a finger or stylus. In some aspects, the method can include implementing a force sensing touch by touching a force sensing virtual button on the touchscreen display having the physical sensing surface. In some aspects, the method can include implementing a proximity sensing interaction by bringing a finger or stylus within a predetermined distance over a proximity sensing zone of the physical sensing surface.

In some embodiments, the multi-modal controller can: generate and display a force sensing virtual button; receive an input to the force sensing virtual button; and implement an operation based on the input to the force sensing virtual button. In some aspects, the multi-modal controller: generates and displays a proximity sensing zone; receives an input above the proximity sensing zone; and implements an operation based on the input to the proximity sensing zone.

In some embodiments, the multi-modal controller determines whether or not the multi-modal touchpad is in motion or stationary. Depending on a motion state or a stationary state the multi-modal controller can: determine whether an input into the physical sensing surface is a true input, and if so, then implement an operation consistent with the true input; or determine whether an input into the physical sensing surface is a false input, and if so, then omitting an operation of the false input.

### DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a system architecture for the multi-modal touchpad.

FIG. 2 illustrates an example of a protocol for physical multi-parameter sensing.

FIG. 3A illustrates an example of key multi-modal functions.

FIG. 3B shows a finger activation and force sensing gesture with a figure.

FIG. 3C shows a stylus activation and force sensing gesture with a stylus.

FIG. 4 shows rectangular force sensing virtual buttons.

FIG. 5A shows proximity zone sensing with a proximity sensing zone on the display and the finger coming into some defined proximity distance.

FIG. 5B shows proximity zone sensing with a proximity sensing zone on the on the display and the stylus coming into some defined proximity distance.

FIG. 6 illustrates an embodiment of a computing device that can include the multi-modal touchpad.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology includes a multi-modal touchpad device that includes a physical sensing surface, a force/pressure sensing element, motion sensing elements, proximity sensing elements, haptic feedback elements, display elements, and a duplex data/controller and corresponding interface.

In some embodiments, the present technology includes protocols to design the multi-modal touchpad device. The protocols to design such a multi-modal touchpad device can include determining and/or varying the features thereof. Some examples of features than can be modulated through design can include determining a size and/or shape of the physical sensing surface, which can be determined relative to the configuration of the computing device that includes the multi-modal touchpad device. For example, the physical sensing surface can be only a portion of a surface or side of the computing device, may be designed to for side to side coverage. The shape may conform with the computing device, or the shape can be altered to be different, ranging from circular to polygons (e.g., triangle, square, rectangle, octagon, or any other). Additionally, various other aspects of the multi-modal touchpad device can be designed to improve performance and usability, such as those described in more detail herein.

In some embodiments, the present technology includes protocols to implement the multi-modal touchpad device in other devices, such as computer devices and computing systems. The multi-modal touchpad device can be included in various types of computer devices, such as standard desktop, laptop, portable computer, stationary computer, mobile, handheld, smart phone, tablet, or other types of computer devices. In fact, the multi-modal touchpad can be implemented with any device that includes a processor, such as a microprocessor, or any device that can receive input from a human. Thus, the multi-modal touchpad can receive human input to communicate with a computing device.

In some embodiments, the multi-modal touchpad device can include methods of interacting with the multi-modal touchpad in order to input information into a computer device or computing system or other device. The input modality can include multi-touch sensing, discrete force/pressure node sensing, and gesture sensing. The output modality can include haptic feedback via the multi-modal touchpad. The output modality may also include displaying illumination on a display of a device, such as a computer device. In some instances, the multi-modal touchpad may be configured as a touch screen, where the information may be displayed upon, and thereby the human input into the multi-modal touchpad can be displayed on the multi-modal touchpad configured as a display.

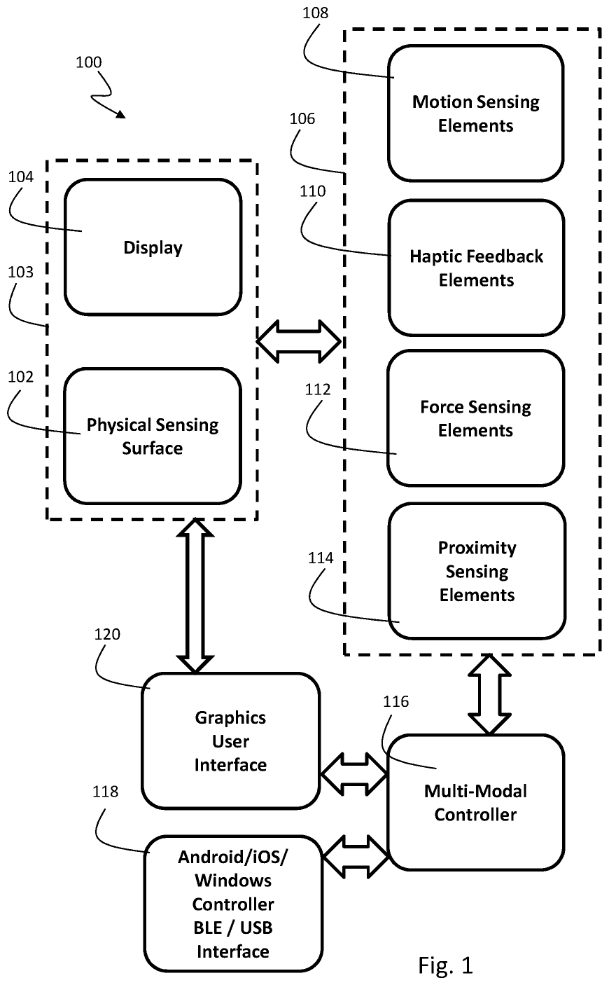

FIG. 1 illustrates a system architecture 100 for the multi-modal touchpad. The system architecture 100 can be represented by key functional blocks, such as those described herein. As shown, the system architecture 100 can include a physical sensing surface 102 and a display 104. The physical sensing surface 102 and display 104 may be separate components, such as the physical sensing surface 102 being in one location and the display 104 being in a different location. However, the physical sensing surface 102 and a display 104 may be combined into a touchscreen configured as described herein as the multi-modal touchpad (e.g., illustrated by the dashed box 103 showing a housing or a touchscreen that is both the display 104 and the physical sensing surface 102). The physical sensing surface 102 can be configured as any external surface of a display 104 or an external surface of any type of device, or external surface of an opaque laptop-style touchpad. The physical sensing surface 102 may look and/or feel like a common touchpad, whether touchscreen or opaque (e.g., dedicated), but may be configured with the components and operability as described herein to be a multi-modal touchpad. The system architecture 100 can include multi-modal sensory elements 106, which can include multi-modal input elements, such as but not limited to a motion sensor 108 configured for motion sensing, a force sensor 112 configured for force sensing, and a proximity sensor 114 for proximity sensing. As such, the motion sensor 108, force sensor 112, and proximity sensor 114 can be operably coupled with the physical sensing surface 102, and may be physically located adjacent or within an operable distance from the physical sensing surface 102. In some aspects, the motion sensor 108 can be located anywhere in a device having the physical sensing surface, and thereby may sense motion of the device.

The system architecture 100 can include multi-modal sensory elements 106 that are configured as multi-modal output sensing elements, such as but not limited to haptic feedback elements 110. The haptic feedback elements 110 can be operably coupled with the physical sensing surface 102, and may be physically located adjacent or within an operable distance from the physical sensing surface 102. The haptic feedback elements 110 may or may not be associated with the motion sensor 108, force sensor 112, and proximity sensor 114. The haptic feedback elements 110 can be associated with the physical sensing surface 102 so that the user can feel the haptic feedback by touch.

The system architecture 100 can include a multi-modal controller 116, which can be configured to perform at least three key functions as well as other standard touchpad functions: multi-parameter sensing (e.g., from sensors), signal processing (e.g., signals from sensors); and control interfacing (e.g., control one or more regions of touchpad for one or more functions), data interfacing (e.g., receiving touch input and providing haptic output), and visualization (e.g., display screen indicators).

The system architecture 100 can include a data interface 118 that is configured to relay information from the multi-modal controller 116 with other processors or components or modules of the computing device. The data interface 118 can be configured to operate and relay information by one or more of USB/BLE/Android/iOS/Windows, or other. These are merely examples of a data interface 118 of a computing system. Accordingly, the data interface 118 can provide two-way data communication between a main controller or processor of the computer and the multi-modal controller 116.

The system architecture can include a graphics user interface 120 that is configured to relay information from the multi-modal controller 116 with a display 104 (e.g., which may be the physical sensing surface 102 when a touchscreen). The graphics user interface 120 may provide data from the multimodal controller 116 communications with a graphics card or graphics module of the computing device and with the display 104 so that the display can illustrate the desired optically viewable output, such as normally displayed on a display screen, which can be the graphics user interface 120. Here, the graphics user interface 120 can provide for the multi-module controller 116 to receive data from the sensors and then provide display data to the display 104 in the form of the graphics user interface 120.

FIG. 1 also shows the duplex data/control interface, where the multi-modal controller can provide data to the data interface 118 and to the graphics user interface 120. As such, the data interface 118 can be used for control of the device having the system architecture 100 from the data provided by the multi-modal controller 116, which was received as input into the physical sensing surface. Also, the graphics user interface 120 can provided to the display 104 from data provided by the multi-modal controller 116, which was received as input into the physical sensing surface. This provides the duplex data/control interface.

Accordingly, FIG. 1 illustrates the system architecture for the multi-modal touchpad which illustrates key functional blocks. The physical sensing surface 102 can include the external surface of a display or an external surface. The multi-modal input sensing elements can include but not limited to motion sensing, force sensing and proximity sensing. The multi-modal output sensing elements can include but not limited to haptic feedback elements. The multi-modal controller can perform three key functions: multi-parameter sensing; signal processing; and control interfacing/data interfacing/visualization. The data interface can include but not limited to USB/BLE/Android/iOS/Windows. The graphics user interface can be displayed on the display.

In some embodiments, the design and implementation of a multi-modal touchpad device is provided. The input modality can include, but not limited to, multi-touch sensing, discrete force/pressure node and gestures. The output modality can include, but not limited to, haptic feedback and display illumination.

A typical computer user interface system includes the use of a touchpad. The touchpad provides key functions including cursor pointing/movement control and display scrolling/viewing control. This invention proposes a unique multi-modal touchpad device comprising of force/pressure sensing elements, motion sensing elements, haptic feedback elements, display elements and duplex data control interface.

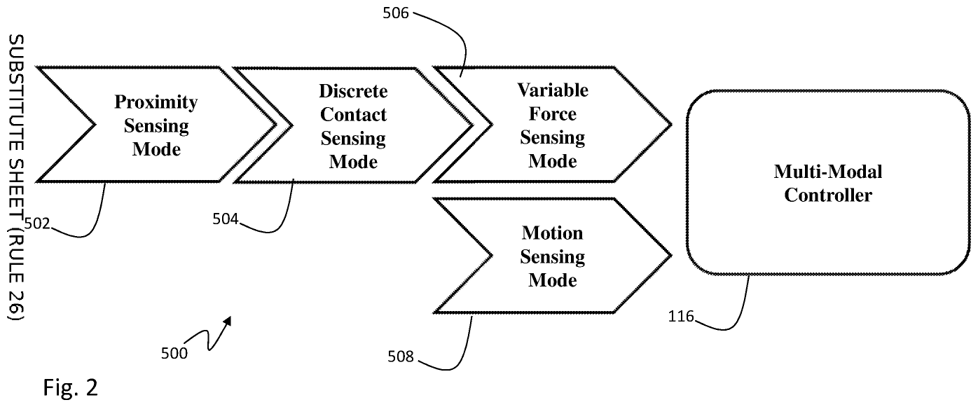

FIG. 2 illustrates an example of a protocol 500 for physical multi-parameter sensing. This protocol 500 can be used with the system architecture 100. The protocol 500 includes a sequence of the following: implementing a proximity sensing mode for proximity sensing 502; implementing a discrete contact sensing mode for discrete contact sensing 504; and implementing a variable force sensing mode for variable force sensing 506. The protocol 500 can be performed when a human (e.g., human finger, but could be any animal phalange) or external stylus interacts with the physical sensing surface 102. Simultaneously or intermittently, the physical sensing surface 102 can also be configured for implementing a motion sensing mode for motion sensing 508. For example, the protocol 500 represents the typical external stimulus of a human user's finger and/or stylus approach when touching the physical sensing surface 102. The physical sensing surface 102 can operate so that the touch (e.g., finger or stylus) can be detected simultaneously with motion sensing. This configuration can allow for enhanced data input into the physical sensing surface 102 in order to identify real and intentional data input, and to distinguish unintentional or erroneous input. In an example, the physical sensing surface 102 can beneficially accept an intentional data input that satisfies certain criteria, and/or reject an unintentional touch of the physical sensing surface 102 (e.g., not satisfying input criteria or satisfying unintentional touch criteria). In an example, multi-the modal touchpad can be included in a vehicle, such as a boat, and interaction therewith may cause some false or unintended interaction with the multi-modal touchpad. In another example, an unintentional interaction with the multi-modal touchpad can occur during excessive vehicle motion, such as a marine vessel affected by the ocean waves. The multi-mode controller 116 can accept the input when above a certain threshold (e.g., specific force threshold and/or duration applied threshold, as satisfying input criteria), and deny the input when the force is below a minimum force threshold and/or below a minimum duration threshold (e.g., not satisfying input criteria).

In some embodiments, the multi-mode controller 116 can determine when the multi-modal touchpad is stationary or moving. For example, the multi-modal touchpad can include motion sensors, such as accelerometers, level meter, gyroscopes, passive infrared, microwave, ultrasonic, tomographic motion detector, vibration detector, shock detector, tilt detector, rotation detector, or others. The data therefrom can be processed to determine whether or not the computing device with the multi-modal touchpad is stationary or moving. The sensitivity thresholds can change between being stationary or moving, and may vary as the movement varies. The variation of sensitivity may also change while a user is walking with a mobile device (e.g., smartphone) and interacting therewith.

FIG. 2 illustrates an example of physical multi-parameter sensing, where the sequence of proximity sensing, discrete contact sensing and variable force sensing represents the typical external stimulus of a human user's finger/stylus approach and touching the physical sensing surface, can be detected simultaneously with motion sensing. An application example can include unintentional touch rejection of a touchpad input during an excessive vehicle motion, such as a marine vessel affected by the ocean waves, unless a specific force with minimum duration is applied.

In some embodiments, the multi-modal touchpad is devoid of the physical sensing surface being operably coupled with a capacitive sensing controller operably that is coupled to a capacitive sensing element. As such, the touchpad may omit a “click” or click like capacitive sensing element. In some aspects, the multi-modal touchpad is devoid of a haptic feedback element operably coupled with a capacitive sensing controller.

In some embodiments, the multi-modal touchpad is devoid of the physical sensing surface being operably controlled with a resistive sensing controller that is coupled to a resistive element. As such, the touchpad may omit resistance based data input.

In some embodiments, the multi-modal touchpad is devoid of the physical sensing surface being operably controlled with a force sensing controller that is coupled to a force element. As such, the touchpad may omit a single one function force sensing controller.

Instead of the capacitive sensing controller, resistive sensing controller, and/or force sensing controller (single mode force only), the present multi-modal touchpad includes a multi-modal controller that interfaces with the display/physical sensing surface, sensing elements, haptic feedback elements, and which multi-modal controller interfaces with the graphics user interface and data interface.

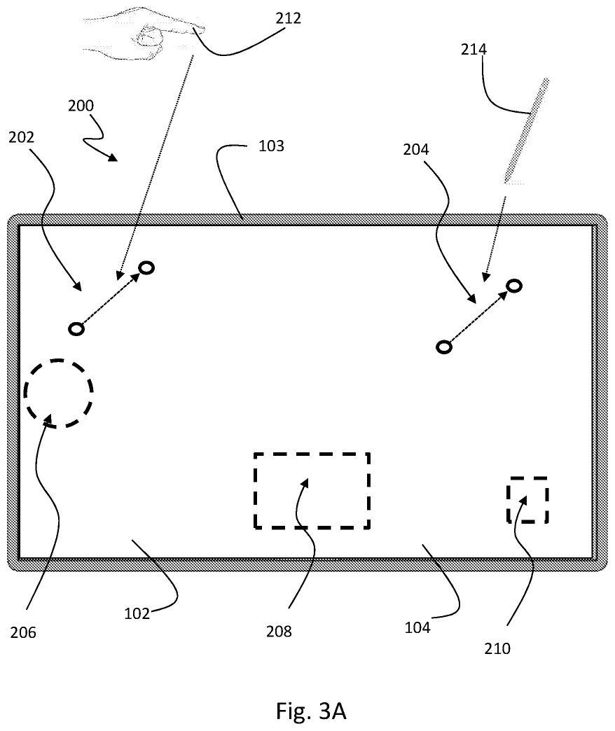

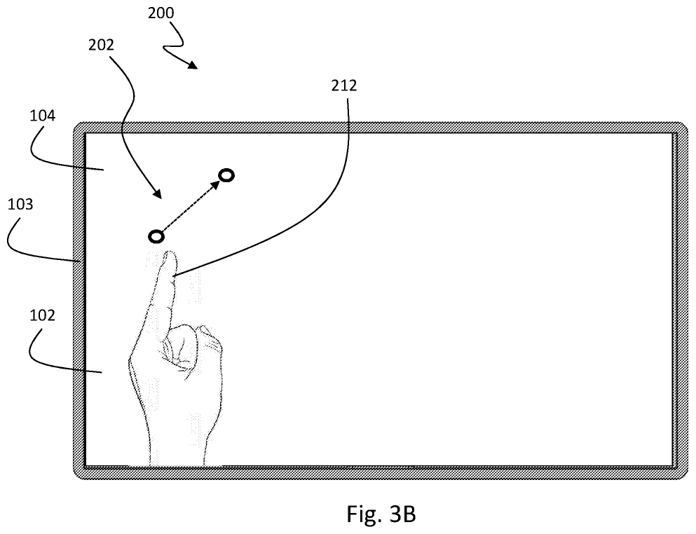

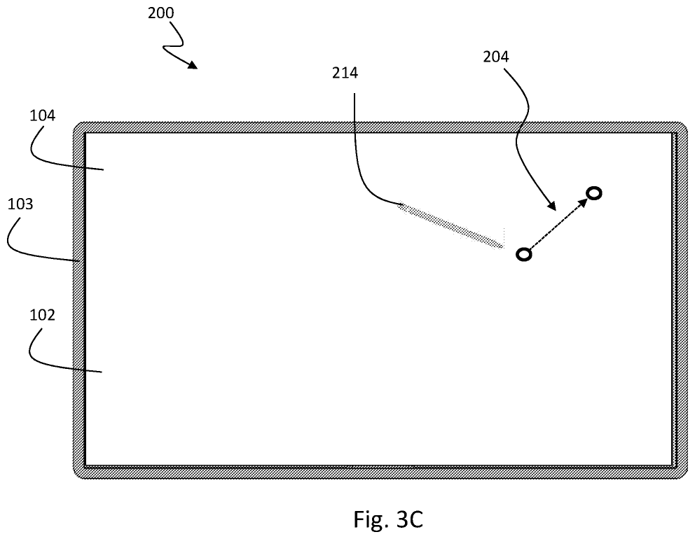

FIG. 3A illustrates an example of key multi-modal functions that are supported simultaneously when the multi-modal touchpad 200 is physically stationary or when moving (e.g., mobile). Here, the multi-modal touchpad 200 is configured with the physical sensing surface 102 also being a display 104. The physical sensing surface 102 and display 104 are held by a housing 103. As shown, a finger activation and force sensing gesture 202 can be implemented. Also, a stylus activation and force sensing gesture 204 can be implemented. The physical sensing surface 102 and display 104 can provide a force sensing virtual button 206, which may be a circle as shown, or any shape. The physical sensing surface 102 and display 104 can provide a proximity sensing zone 208, which may be a rectangle as shown, or any shape. The physical sensing surface 102 and display 104 can provide a force sensing virtual button 210, which may be a rectangle as shown, or any shape. Accordingly, a finger activation and force sensing gestures 202 can be implemented when the user's finger 212 is in contact with the physical sensing surface 102 of the multi-modal touchpad 200, and may interact with the force sensing virtual button 206 or close thereto or interact with illustrations on the display 104. Additionally, a stylus activation and force sensing gesture 204 can be implemented when a stylus 214 is in contact with the physical sensing surface 102 of the multi-modal touchpad 200, and may interact with the force sensing virtual button 210 or close thereto or interact with illustrations on the display 104. The virtual buttons 206, 210 (e.g., force sensing) can be provided on the display 104 with reconfigurable locations and pre-determined geometric shapes, such as circle or rectangle. The virtual buttons 206, 210 can be used as a replacement of physical mechanical buttons of a typical touchpad.

The proximity sensing zone 208 can be provided on the display 104, where the presence of an object or finger can be detected by the physical sensing surface 102 of the multi-modal touchpad 200. The proximity sensing zone 208 can be configured as any proximity sensor, which are known in the art, such as for example, capacitive, capacitive displacement, doppler effect, inductive, optical (e.g., photoelectric, photocell, laser rangefinder, passive charge-coupled, passive thermal infrared, or others), or others.

Accordingly, FIG. 3A illustrates an example of key multi-modal functions that are supported simultaneously when the touchpad is physically stationary. Finger activation and force sensing gestures can be performed when the user's finger is in contact with the physical surface of the touchpad. Stylus activation and force sensing gestures can be performed when a stylus is in contact with the physical surface of the touchpad. Virtual buttons (force sensing) can be displayed with reconfigurable locations of pre-determined geometric shapes, such as circle or rectangle, providing replacement of physical mechanical buttons of a typical touchpad. Proximity sensing zones can be provided where the presence of an object or finger can be detected.

Also, FIG. 3A illustrates an example of key multi-modal functions that are supported simultaneously when the touchpad is physically moving, by incorporating motion sensing as well. When mobile due to motion sensing, optionally the stylus sensing and activation can be turned off or deactivated. This deactivation can be automatic or set by the user. However, the stylus operability may be maintained during movement where the motion sensing is activated.

FIG. 3B shows a finger activation and force sensing gesture 202 with a finger 212, whether the device is stationary or moving (e.g., mobile).

FIG. 3C shows a stylus activation and force sensing gesture 204 with a stylus 214, whether the device is stationary or moving (e.g., mobile).

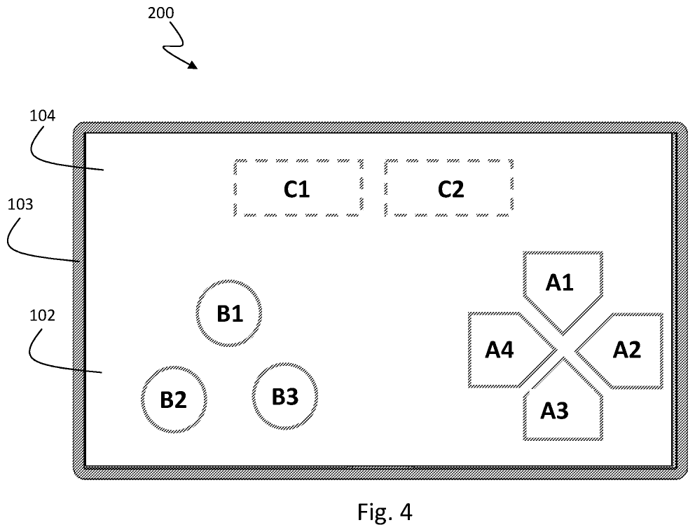

FIG. 4 shows rectangular force sensing virtual buttons that are rectangular C1, C2, circular B1, B2, B3, and odd shape A1, A2, A3, A4 (e.g., or directional shape with point pointing in a direction), whether the device is stationary or moving (e.g., mobile).

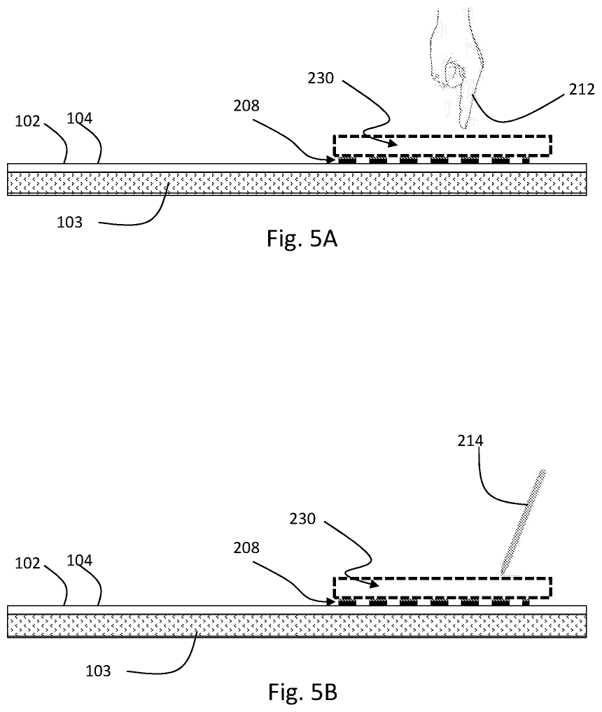

FIG. 5A shows proximity zone sensing with a proximity sensing zone 208 on the display 104 and the finger 212 coming into some defined proximity distance, whether the device is stationary or moving (e.g., mobile). As such, there is an air gap 230 between the finger 212 and the physical sensing surface 102.

FIG. 5B shows proximity zone sensing with a proximity sensing zone 208 on the on the display 104 and the stylus 214 coming into some defined proximity distance. As such, there is an air gap 230 between the stylus 214 and the physical sensing surface 102.

As such, a user can implement a mechanical movement based force sensing by using the finger with the physical sensing surface 102. Also, a user can implement a mechanical movement based force sensing by using the stylus with the physical sensing surface 102. The motion can come into proximity and/or actually touch the physical sensing surface 102 and performing a movement with the finger or stylus, such as a swipe, which can be a movement in a defined direction (e.g., toward edge or point) or random. As such, an activation gesture can be performed in order to activate the physical sensing surface 102, or can be used during data input to the physical sensing surface 102. Such an activation gesture can be performed when the multi-modal touchpad 200 is stationary. However, an activation gesture may also be used when the multi-modal touchpad 200 is in motion. For example, this is not a capacitive touchpad function, but instead the proximity sensor or force sensor provide the sensing for activation.

In some embodiments, the FIGS. 3A-3C, 4, and 5A-5B may also provide examples of mobile multi-modal touchpad function, where the multi-modal touchpad 200 can be operated with the figure or stylus while in motion. Thus, the multi-modal touchpad 200 can operate while stationary and while in motion. This provides an example of key multi-modal functions that are supported simultaneously when the touchpad is physically mobile, by incorporating motion sensing as well.

In some embodiments, the invention includes a multi-modal touchpad device that includes force/pressure sensing elements, motion sensing elements, haptic feedback elements, display elements, and a duplex data/control interface. Also, protocols for designing the multi-modal touchpad device and implementing the multi-modal touchpad device in a device (e.g., computer) are provided. The multi-modal touchpad device can be included in various types of computer devices, such as standard desktop, laptop, portable stationary, mobile, handheld, or other types of computer devices. In fact, the multi-modal touchpad can be implemented with any device that includes a processor, such as a microprocessor, or any device that can receive input from a human. Thus, the multi-modal touchpad can receive human input to communicate with a device.

The multi-modal touchpad device can include methods of interacting with the multi-modal touchpad in order to input information into a computer device or computing system or other device. The input modality can include multi-touch sensing, discrete force/pressure node sensing, and gesture sensing. The output modality can include haptic feedback via the multi-modal touchpad. The output modality may also include displaying illumination on a display of a device, such as a computer device. In some instances, the multi-modal touchpad may be configured as a touchscreen, where the information may be displayed upon, and thereby the human input into the multi-modal touchpad can be displayed on the multi-modal touchpad configured as a display. In view of the descriptions herein, the multi-modal touchpad can include at least the following four embodiments, as well as others: 1) Multi-modal features excluding proximity sensing and excluding motion sensing; 2) Multi-modal features including proximity sensing and excluding motion sensing; 3) Multi-modal features excluding proximity sensing and including motion sensing; and 4) Multi-modal features including proximity sensing and including motion sensing.

In any of the embodiments, the device can be held in one hand and operated by the other hand, such as with the finger or stylus.

In some embodiments, a multi-modal touchpad can include: a physical sensing surface; a force sensor operably coupled with the physical sensing surface; a proximity sensor operably coupled with the physical sensing surface; a motion sensor; a haptic feedback device operably coupled with the physical sensing surface; a multi-modal controller operably coupled with: the force sensor so as to receive force sensor data from the force sensor, the proximity sensor so as to receive proximity sensor data from the proximity sensor, the motion sensor so as to receive motion sensor data from the motion sensor, and the haptic feedback device so as to provide instructional haptic data to the haptic feedback device.

In some embodiments, a multi-modal touchpad can include: a physical sensing surface; a force sensor operably coupled with the physical sensing surface; a haptic feedback device operably coupled with the physical sensing surface; a multi-modal controller operably coupled with: the force sensor so as to receive force sensor data from the force sensor, and the haptic feedback device so as to provide instructional haptic data to the haptic feedback device.

In some embodiments, a multi-modal touchpad can include: a physical sensing surface; a force sensor operably coupled with the physical sensing surface; a proximity sensor operably coupled with the physical sensing surface; a haptic feedback device operably coupled with the physical sensing surface; a multi-modal controller operably coupled with: the force sensor so as to receive force sensor data from the force sensor, the proximity sensor so as to receive proximity sensor data from the proximity sensor, and the haptic feedback device so as to provide instructional haptic data to the haptic feedback device.

In some embodiments, a multi-modal touchpad can include: a physical sensing surface; a force sensor operably coupled with the physical sensing surface; a motion sensor; a haptic feedback device operably coupled with the physical sensing surface; a multi-modal controller operably coupled with: the force sensor so as to receive force sensor data from the force sensor, the motion sensor so as to receive motion sensor data from the motion sensor, and the haptic feedback device so as to provide instructional haptic data to the haptic feedback device.

In some embodiments, the multi-modal touchpad in accordance with one of the embodiments can include a display, wherein the display is operable coupled with the multi-modal controller so as to receive display data from the multi-modal controller. In some aspects, the display is separate and distinct from the touchpad, such as being a standalone or integrated screen that is separate from the touchpad and not a touchscreen. In some aspects, the display is a touchscreen such that the touchpad is optically transmissive to the display elements of the display. A touchscreen can be configured as a multi-modal touchpad as described herein. In some aspects, the display is a touch screen display, and the physical sensing surface is a surface of the display.

In some embodiments, the multi-modal touchpad can include a data interface that couples the multi-modal controller with an operating system of a device having the multi-modal touchpad. This coupling can be to a module or a microprocessor of the computing device having the multimodal touchpad. This configuration allows for interaction of the device as per the operating system to provide input therein and obtain output therefrom with regard to the multi-modal touchpad.

In some embodiments, the multi-modal touchpad can include a graphics user interface that couples with multi-modal controller with the display so as to relay display data from the multi-modal controller to the display. The graphics user interface can be a visual way of interacting with a computer using items such as windows, icons, and menus, used by most modern operating systems. The graphics user interface can provide the visual output data to the multi-modal controller, which then provides the visual output data with or without any of the virtual sensing buttons or other to the display. Alternatively, the multi-modal controller can provide data from the sensors or feedback elements to the graphics user interface module, which then can provide the visual data to the display without or without the visual data processing back through the multi-modal controller so as to provide the display with the visual data with or without the virtual sensing buttons.

In some embodiments, the force sensor is configured as: a discrete contact sensor; and/or a variable force sensor. That is, the threshold of force to be recognized as input can be variable depending on motion or other parameters, which allows for dynamic operability during use in motion, such as in a vehicle. Also, the threshold may be set, such as during manufacturing, or by a user through the interface, to adjust the set amount of force to be recognized as input. In some aspects, the force sensor is two separate sensors, which can be a discrete contact sensor; and a variable force sensor. Accordingly, in some aspects, the multi-modal controller is configured to operate with the force sensor, such as providing data regarding a force sensing button and receiving data regarding sensed forces. This allows the multi-modal controller to generate and display a force sensing virtual button. Also, the multi-modal controller may be able to generate and display a proximity sensing zone, where providing data regarding a proximity sensing button and receiving data regarding sensed proximities by the finger or stylus, or other proximity tool.

In some embodiments, the multi-modal controller is configured to: generate and display a force sensing virtual button; and receive an input into the force sensing virtual button. In some aspects, the multi-modal controller is configured to: generate and display a proximity sensing zone; and receive an input above the proximity sensing zone. In some aspects, the multi-modal controller is configured to: receive an activation by force sensing gesture; and implement an operation based on the force sensing gesture.

In some embodiments, the multi-modal controller is configured to determine whether or not the multi-modal touchpad is in motion. In some aspects, the multi-modal controller is configured to determine whether or not the multi-modal touchpad is stationary. In some aspects, the multi-modal controller is configured to determine whether or not a finger or stylus is within a predetermined distance from the physical sensing surface. In some aspects, the multi-modal controller is configured to determine whether an input into the physical sensing surface is a true input, and if so, then implement an operation consistent with the true input. In some aspects, the multi-modal controller is configured to determine whether an input into the physical sensing surface is a false input, and if so, then omitting an operation of the false input.

In some embodiments, a kit can include: the multi-modal touchpad in accordance with one of the embodiments; and a stylus adapted to operate with the physical sensing surface. In some aspects, the stylus can include a magnetic tip that can interact with a magnetic proximity sensor. The tip can be covered with a soft or gel coating to allow contact with the screen without scratching or other damage.

In some embodiments, a device can include: the multi-modal touchpad in accordance with one of the embodiments; and a housing having the multi-modal touchpad. In some aspects, the device is a computing device. In some aspects, the device is a handheld computing device.

In some embodiments, a method of operating the multi-modal touchpad can include: providing the multi-modal touchpad; and inputting data by interacting with the multi-modal touchpad by proximity actions and/or touch actions. In some aspects, the touch actions can include discrete contact touches and/or variable force contact touches. In some aspects, the method can include implementing an activation and force sensing gesture with a finger or stylus. In some aspects, the method can include implementing a force sensing touch by touching a force sensing virtual button on the touchscreen display having the physical sensing surface. In some aspects, implementing a proximity sensing interaction is performed by bringing a finger or stylus within a predetermined distance over a proximity sensing zone of the physical sensing surface. In some aspects, the method excludes proximity sensing and/or excludes motion sensing. In some aspects, these features can be turned on and off by a user, such as by interacting with the touchpad and selecting icons or options to control how the touchpad operates. In some aspects, the method includes proximity sensing and excludes motion sensing. In some aspects, the method excludes proximity sensing and includes motion sensing. In some aspects, the method includes proximity sensing and includes motion sensing.

In some aspects, a method for designing the multi-modal touchpad of one of the claims can include: determining size and/or shape of the physical sensing surface; determining a location of the force sensor relative to the physical sensing surface; determining a location of the proximity sensor relative to the physical sensing surface; determining a location of the motion sensor relative to the physical sensing surface; determining a location of the haptic feedback device relative to the physical sensing surface; determining a location of the multi-modal controller relative to the physical sensing surface; and determining data lines between the multi-modal controller and at least one of the force sensor, proximity sensor, motion sensor, and haptic feedback device.

In some embodiments, a method of manufacturing the multi-modal touchpad of one of the embodiments can include: obtaining a design of the multi-modal touchpad; fabricating the physical sensing surface; operably coupling the force sensor with the physical sensing surface; operably coupling the proximity sensor relative to the physical sensing surface; operably coupling the haptic feedback device relative to the physical sensing surface; placing the motion sensor in a housing having the multi-modal touchpad; and operably coupling the multi-modal controller operably with: the force sensor so as to receive force sensor data from the force sensor, the proximity sensor so as to receive proximity sensor data from the proximity sensor, the motion sensor so as to receive motion sensor data from the motion sensor, and the haptic feedback device so as to provide instructional haptic data to the haptic feedback device. In some aspect, the method can include: manufacturing the display; and coupling the display with the housing. In some aspects, the method of manufacturing can include: configuring the display as a touchscreen; and associating the touchscreen with the physical sensing surface.

For the embodiments and other processes and methods disclosed herein, the operations performed in the processes and methods may be implemented in differing order. Furthermore, the outlined operations are only provided as examples, and some operations may be optional, combined into fewer operations, eliminated, supplemented with further operations, or expanded into additional operations, without detracting from the essence of the disclosed embodiments.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

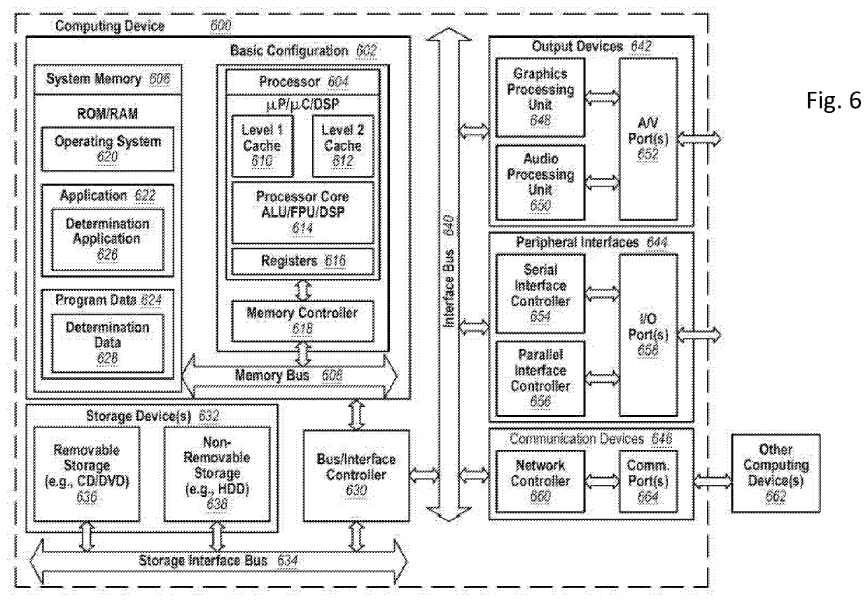

FIG. 6 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A multi-modal touchpad comprising:
a display having a physical sensing surface and configured as a touchscreen;
at least one type of input sensor operably coupled with the physical sensing surface;
a motion sensor;
a haptic feedback device operably coupled with the physical sensing surface; and
a multi-modal controller operably coupled with:
the at least one type of input sensor so as to receive sensor data therefrom;
the motion sensor so as to receive motion sensor data therefrom;
the haptic feedback device so as to provide instructional haptic data to the haptic feedback device;
a data interface that operably couples the multi-modal controller with an operating system of a device having the multi-modal touchpad; and
a graphics user interface provided from the multi-modal controller to the display so as to display data from the multi-modal controller to the display.

2. The multi-modal touchpad of claim 1, the at least one type of input sensor comprising:
a force sensor operably coupled with the physical sensing surface, wherein the multi-modal controller is operably coupled with the force sensor so as to receive force sensor data from the force sensor.

3. The multi-modal touchpad of claim 1, the at least one type of input sensor comprising:
a proximity sensor operably coupled with the physical sensing surface, wherein the multi-modal controller is operably coupled with the proximity sensor so as to receive proximity sensor data from the proximity sensor.

4. The multi-modal touchpad of claim 1, wherein the display is operable coupled with the multi-modal controller so as to receive display data from the multi-modal controller, wherein the display is a touch screen display, and the physical sensing surface is a surface of the display.

5. The multi-modal touchpad of claim 1, wherein the multi-modal controller receives data from the data interface such that the multi-modal controller receives data to display on the display, wherein the multi-modal controller is configured to provide a virtual sensor region on the display with respect to the data from the data interface.

6. The multi-modal touchpad of claim 5, wherein the multi-modal controller is configured to define at least one of a force sensing region or proximity sensing zone on the display.

7. The multi-modal touchpad of claim 1, wherein the multi-modal controller receives sensor data from the at least one type of sensor and provides haptic feedback data to the haptic feedback device.

8. The multi-modal touchpad of claim 2, wherein the force sensor is at least one force sensor configured as:
a discrete contact sensor; and/or
a variable force sensor.

9. The multi-modal touchpad of claim 8, wherein the multi-modal controller is configured to:
generate and display a force sensing virtual button;
receive an input to the force sensing virtual button; and
implement an operation based on the input to the force sensing virtual button.

10. The multi-modal touchpad of claim 3, wherein the multi-modal controller is configured to:
generate and display a proximity sensing zone;
receive an input above the proximity sensing zone; and
implement an operation based on the input to the proximity sensing zone.

11. The multi-modal touchpad of claim 1, wherein the multi-modal controller is configured to determine whether or not the multi-modal touchpad is in motion or stationary.

12. The multi-modal touchpad of claim 11, wherein the multi-modal controller is configured to:
determine whether an input into the physical sensing surface is a true input, and if so, then implement an operation consistent with the true input; and/or
determine whether an input into the physical sensing surface is a false input, and if so, then omitting an operation of the false input.

13. A device comprising:
the multi-modal touchpad of claim 1;
a housing having the multi-modal touchpad.

14. A method of operating a device with a multi-modal touchpad, the method comprising:
providing the device of claim 13 having the multi-modal touchpad; and
inputting data by interacting with the multi-modal touchpad by proximity actions and/or touch actions such that the multi-modal controller receives input data from the proximity sensor and/or the force sensor and provides output data to the display and the haptic feedback device,
wherein the multi-model controller determines whether the device is in motion or stationary.

15. The method of claim 14, further comprising:
receiving data from the data interface such that the multi-modal controller receives data to display on the display; and
providing a virtual sensor region on the display with respect to the data from the data interface by the multi-modal controller.

16. The method of claim 15, further comprising defining at least one of a force sensing region or proximity sensing zone on the display by the multi-modal controller.

17. The method of claim 14, wherein the haptic feedback device provides a haptic feedback, wherein the multi-modal controller receives an input and generates haptic feedback data in response to the input.

18. The method of claim 14, wherein the interacting with the multi-modal touchpad include touch actions that are discrete contact touches and/or variable force contact touches.

19. The method of claim 18, comprising implementing a force sensing touch by touching a force sensing virtual button on the touchscreen display having the physical sensing surface.

20. The method of claim 14, comprising implementing a proximity sensing interaction by bringing a finger or stylus within a predetermined distance over a proximity sensing zone of the physical sensing surface.

21. The method of claim 14, further comprising the multi-modal controller:
generating and displaying a force sensing virtual button;
receiving an input to the force sensing virtual button; and
implementing an operation based on the input to the force sensing virtual button.

22. The method of claim 14, further comprising the multi-modal controller:
generating and displaying a proximity sensing zone;
receiving an input above the proximity sensing zone; and
implementing an operation based on the input to the proximity sensing zone.

23. The method of claim 14, further comprising the multi-modal controller:
determining whether or not the multi-modal touchpad is in motion or stationary, and depending on a motion state or a stationary state:
determining whether an input into the physical sensing surface is a true input, and if so, then implement an operation consistent with the true input; or
determining whether an input into the physical sensing surface is a false input, and if so, then omitting an operation of the false input.
